(19) United States
(12) Patent Application Publication
(10) Pub. No.: US 2007/0223177 A1
(43) Pub. Date: Sep. 27, 2007

(54) Multilayer electronic device and the production method

(75) Inventors: Kazushige Ito, Yokohama (JP); Kouji Tanaka, Nikaho-shi (JP); Makoto Takahashi, Nikaho-shi (JP); Akitoshi Yoshii, Yurihonjo-shi (JP); Masayuki Okabe, Nikaho (JP)

Correspondence Address: OLIFF & BERRIDGE, PLC, P.O. BOX 19928, ALEXANDRIA, VA, 22320, US

(73) Assignee: TDK CORPORATION, TOKYO (JP)

(21) Appl. No.: 11/725,483

(22) Filed: Mar. 20, 2007

(30) Foreign Application Priority Data
Mar. 27, 2006 (JP) 2006-084751

(51) Int. Cl. H01G 4/06

(52) U.S. Cl. 361/321.2

(57) ABSTRACT

A production method of a multilayer electronic device having an element body configured by alternately stacked dielectric layers and internal electrode layers: wherein a particle diameter α of conductive particles and a particle diameter β of co-material particles satisfies a relationship of α/β=0.8 to 8.0, and an adding quantity of the co-material particles to the conductive paste is larger than 30 wt % and smaller than 65 wt %.

### BACKGROUND OF THE INVENTION

1. Field of the Invention

The present invention relates to a multilayer electronic device having excellent humidity resistance, wherein electrodes hardly break particularly in the outermost internal electrode layer in the stacking direction, and the production method.

2. Description of the Related Art

In recent years, along with downsizing and increasing capacitance of a capacitor, multilayer ceramic capacitors as multilayer electronic devices are demanded to have thinner dielectric layers and internal electrode layers with less defects.

To satisfy such demands, an increase of the number of dielectric layers and internal electrode layers and realization of thinner layers in a multilayer ceramic capacitor have been pursued. However, when a base metal Ni is used as the internal electrodes, a shrinkage difference arises between Ni and dielectric particles composing the dielectric layers because Ni has a lower melting point comparing with dielectrics and the difference of sintering temperatures is large. Consequently, it results in arising delamination and cracks, declining capacitance and rising a defective rate.

To overcome the disadvantages, there has been used a method of adding as co-material particles dielectric particles having the same composition as that of the dielectric layers to the electrode paste (refer to the Japanese Unexamined Patent Publication No. 2005-129591, the Japanese Unexamined Patent Publication No. 2004-311985, the Japanese Unexamined Patent Publication No. H07-201222 and the Japanese Unexamined Patent Publication No. H05-190373). As a result that the co-material particles are included with Ni particles in the electrode paste, spheroidizing due to grain growth of Ni can be suppressed to some extent. Particularly, the Japanese Unexamined Patent Publication No. 2005-129591 discloses a method of adding a co-material in an amount of 2 to 20 wt % for suppressing delamination and cracks between internal electrode layers and dielectric layers.

However, a particle diameter ratio of the Ni particles and co-material particles is not specified in the related art. In a multilayer electronic device obtained by the Japanese Unexamined Patent Publication No. 2005-129591, electrode breaking could easily occur on an electrode surface of an outermost electrode layer in the stacking direction among the stacked electrode layers and crush or destruction could be caused due to intrusion of moisture from the broken part under a highly humid condition.

### SUMMARY OF THE INVENTION

An object of the present invention is to provide a multilayer electronic device having high humidity resistance, wherein an electrode coverage rate of the outermost internal electrode layer in the stacking direction is improved and crush or destruction is not caused from an electrode broken part of the outermost internal electrode layer even under a highly humid condition, and the production method.

To attain the above object, according to the present invention, there is provided a production method of a multilayer electronic device configured that dielectric layers formed by using dielectric paste and internal electrode layers formed by using conductive paste are alternately stacked:

wherein

the conductive paste is added with conductive particles and co-material particles;

when assuming that an average particle diameter of the conductive particles is a and an average particle diameter of the co-material particles is β in the conductive paste, α/β is 0.8 to 8.0; and

the co-material particles are added by a ratio of larger than 30 wt % and smaller than 65 wt % with respect to 100 parts by weight of the conductive particles.

The present inventors have found that an electrode coverage rate of the outermost internal electrode layer (hereinafter, also referred to as “the outermost layer electrode coverage rate”) could become high and humidity resistance could become high (for example, being tolerable under a highly humid condition for 1500 hours or longer) by setting a ratio of a particle diameter of conductive particles and a particle diameter of co-material particles to be in a specified range in addition to setting an adding quantity of the co-material particles to the conductive particles to be in a specified range.

Namely, according to the present invention, it is possible to provide a multilayer electronic device, such as a multilayer ceramic capacitor, having a high outermost layer electrode coverage rate and high humidity resistance.

Preferably, conductive particles and co-material particles, wherein α/β is 1.0 to 5.0, are used. By setting to be in this range, the outermost layer electrode coverage rate can be improved and the humidity resistance can be improved.

Preferably, Ni particles are used as the conductive particles.

A material of the dielectric layers is not particularly limited and is composed of a dielectric material, such as CaTiO₃, SrTiO₃ and/or BaTiO₃, but BaTiO₃ particles are preferably used as the dielectric particles.

Preferably, a ratio of the co-material particles to be added with respect to 100 parts by weight of the conductive particles is 40 wt % or larger to 60 wt % or smaller. By setting to be in this range, the outermost layer electrode coverage rate can be furthermore improved and the humidity resistance can be improved.

A multilayer electronic device according to the present invention is not particularly limited and multilayer ceramic capacitors, piezoelectric elements, chip inductors, chip varisters, chip thermisters, chip resistors and other surface mounted (SMD) chip type electronic devices may be mentioned.

### BRIEF DESCRIPTION OF DRAWINGS

These and other objects and features of the present invention will become clearer from the following description of the preferred embodiments given with reference to the attached drawings, in which:

FIG. 1 is a sectional view of a multilayer ceramic capacitor according to an embodiment of the present invention; and

FIG. 2 is a schematic view of key parts for explaining electrode breaking.

### DESCRIPTION OF THE PREFERRED EMBODIMENT

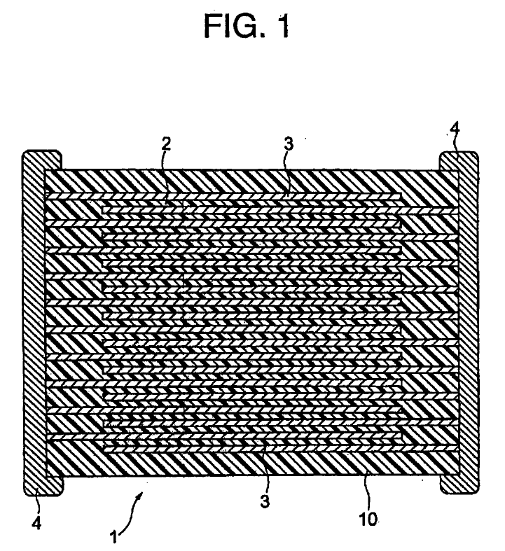

In the present embodiment, a multilayer ceramic capacitor 1 shown in FIG. 1 will be taken as an example of a multilayer electronic device, and the configuration and production method will be explained.

As shown in FIG. 1, the multilayer ceramic capacitor 1 as a multilayer electronic device according to an embodiment of the present invention has a capacitor element body 10, wherein dielectric layers 2 and internal electrode layers 3 are alternately stacked. On both end portions of the capacitor element body 10, a pair of external electrodes 4 are formed to respectively conduct to the internal electrode layers 3 alternately arranged inside the element body 10. The internal electrode layers 3 are stacked so that the end surfaces are alternately exposed to facing surfaces of the two end portions of the capacitor element body 10.

The pair of external electrodes 4 are formed on both end portions of the capacitor element body 10 and connected to exposed end surfaces of the alternately arranged internal electrode layers 3 so as to configure a capacitor circuit. A shape of the capacitor element body 10 is not particularly limited, but it is normally a rectangular parallelepiped shape. Also, the size is not particularly limited and may be a suitable size in accordance with application, but is normally (0.6 to 5.6 mm)×(0.3 to 5.0 mm)×(0.3 to 1.9 mm) or so. The dielectric layers 2 are not particularly limited and composed, for example, of a dielectric ceramic composition satisfying the X8R characteristics of the EIA standard explained below. Note that the X8R characteristics indicates a characteristic of a capacitance change rate ΔC/C=within ±15% at −55 to 150° C.

A dielectric material according to the present embodiment includes a dielectric oxide expressed by a composition formula of (Ba₁₋ₓ Caₓ)ₘ (Ti_{1-y} Zr_{y})O₃ as a major component. At this time, an oxygen (O) amount may be a little deviated from the above stoichiometric composition.

In the above formula, “X” is preferably 0≦x≦0.15 and, more preferably, 0.02≦x≦0.10. The “x” indicates the number of Ca atoms, and a phase transition point of the crystal can be freely shifted by changing the “x”, that is, a Ca/Ba ratio. Therefore, a capacitor-temperature coefficient and specific permittivity can be freely controlled.

In the above formula, “y” is preferably 0≦y≦1.00 and, more preferably 0.05≦y≦0.30. The “y” indicates the number of Ti atoms, and there is a tendency that the reduction resistance becomes furthermore higher by replacing TiO₂ by ZrO₂ which is harder to be reduced comparing with TiO₂. Note that, in the present invention, a ratio of Zr and Ti may be any and only one of the two may be included.

In the above formula, the “m” is preferably 0.995≦m≦1.020 and, more preferably, 1.000≦m≦1.006. By setting the “m” to 0.995 or larger, formation of semiconductor can be prevented when fired in a reducing atmosphere. By setting the “m” to 1.020 or smaller, a fine sintering body can be obtained without heightening the firing temperature.

The dielectric layers 2 include first to fourth subcomponent below in addition to the above main component: a first subcomponent including at least one kind selected from MgO, CaO, BaO and SrO, a second subcomponent including a silicon oxide as its main component, a third subcomponent including at least one kind selected from V₂O₅, MoO₃ and WO₃, and a fourth subcomponent including an oxide of R (note that R is at least one kind selected from Sc, Y, La, Ce, Pr, Nd, Pm, Sm, Eu, Gd, Tb, Dy, Ho, Er, Tm, Yb and Lu) are included.

Ratio of each subcomponent with respect to 100 moles of the main component is

first subcomponent: 0.1 to 5 moles,

second subcomponent 1 to 10 moles,

third subcomponent: 0.01 to 0.2 mole, and

fourth subcomponent 0.1 to 12 moles; and more preferably,

first subcomponent: 0.2 to 2.0 moles,

second subcomponent 2 to 5 moles,

third subcomponent: 0.05 to 0.1 mole, and

fourth subcomponent 0.2 to 8 moles.

Note that the ratio of the fourth subcomponent is not a mole ratio of an oxide of R but a mole ratio of an R element alone. Namely, for example, when using an oxide of Y is used as the fourth subcomponent (an oxide of R), a ratio of the fourth subcomponent being 1 mole means a ratio of the Y element being 1 mole, and not a ratio of Y₂O₃ being 1 mole.

As a result that the first to fourth subcomponents are included in addition to the main component having the above predetermined composition, the capacity-temperature characteristic can be improved while maintaining high permittivity and, particularly, the X8R characteristics of the EIA standard can be satisfied. Preferable contents of the first to fourth subcomponents are as above and the reasons are as below.

The first subcomponent (MgO, CaO, BaO and SrO) exhibits an effect of flattening the capacity-temperature characteristic. When a content of the first subcomponent is too small, a temperature change rate of the capacitance may become large on the other hand, when the content is too much, the sinterability may decline. Note that component ratios of respective oxides in the first subcomponent may be any.

The second subcomponent includes a silicon oxide as its main component and is preferably at least one kind selected from SiO₂, MO (note that M is at least one kind selected from Ba, Ca, Sr and Mg), Li₂O and B₂O₃. The second subcomponent mainly acts as a sintering aids and has an effect of improving a defective rate of initial insulation resistance when layers are made thin. When a content of the second subcomponent is too small, the capacity-temperature characteristic declines and the IR (insulation resistance) declines. On the other hand, when the content is too large, the IR lifetime becomes insufficient and the specific permittivity abruptly declines.

Note that, in the present embodiment, a compound expressed by (Ba, Ca)ₓ SiO₂₊ₓ. (note that x=0.7 to 1.2) may be used as the second subcomponent. The first subcomponent also includes BaO and CaO in the [(Ba, Ca)ₓ SiO₂₊ₓ], and since (Ba, Ca)ₓ SiO₂₊ₓ as a composite oxide has a low melting point, it has preferable reactivity with the main component. Therefore, BaO and/or CaO can be also added as the composite oxide. Note that a ratio of Ba and Ca may be any and only one of the two may be included.

The third subcomponent (V₂O₅, MoO₃ and WO₃) exhibits an effect of flattening a capacity-temperature characteristic at the Curie's temperature or higher and an effect of improving the IR lifetime. When a content of the third subcomponent is too small, the effects become insufficient. On the other hand, when the content is too large, the IR declines remarkably. Note that component ratios of respective oxides in the third subcomponent may be any.

The fourth subcomponent (an oxide of R) has an effect of shifting the Curie's temperature to the high temperature side and an effect of flattening the capacity-temperature characteristic. When a content of the fourth subcomponent is too small, the effects become insufficient and the capacity-temperature characteristic 6 declines. On the other hand, when the content is too large, the sinterability tends to decline. In the present embodiment, Y, Dy, Ho, Er, Tm and Yb are preferable among the R elements because the effect of improving the characteristics is high.

Preferably, the dielectric layers 2 furthermore include a fifth subcomponent including MnO or Cr₂O₃, and a sixth subcomponent including CaZrO₃ or CaO+ZrO₂ in addition to the main component and the first to fourth subcomponents as above.

Ratios of the fifth subcomponent and the sixth subcomponent with respect to 100 moles of the main component are preferably,

fifth subcomponent: 0.1 to 2.5 moles, and

sixth subcomponent: 0 to 5 moles (note that 0 is not included), and more preferably,

fifth subcomponent: 0.1 to 0.5 mole, and

sixth subcomponent: 1.0 to 3.0 moles. Note that the ratio of the fifth subcomponent is not a mole ratio of an oxide of Mn or an oxide of Cr, but is a mole ratio of a Mn element or Cr element alone.

The fifth subcomponent exhibits an effect of accelerating sintering, an effect of heightening the IR and an effect of improving the IR lifetime. When a content of the fifth subcomponent is too small, the effects cannot be fully brought out. On the other hand, when the content is too large, it is liable that the capacity-temperature characteristic may be adversely affected.

The sixth subcomponent (CaZrO₃ or CaO+ZrO₂) exhibits an effect of shifting the Curie's temperature to the high temperature side and an effect of flattening the capacity-temperature characteristic. Also, it has an effect of improving the CR product and direct current insulation breakdown strength. Note that when a content of the sixth subcomponent is too large, the IR accelerated lifetime declines remarkably and the capacity-temperature characteristic (X8R characteristics) declines.

As other subcomponent, Al₂O₃, etc. may be mentioned.

An average crystal grain diameter of the dielectric material is not particularly limited and may be suitably determined, for example, in a range of 0.1 to 3 μm in accordance with a thickness of the dielectric layer, etc. The capacity-temperature characteristic tends to deteriorate as the dielectric layer becomes thinner and as the average crystal grain diameter becomes smaller. Therefore, the dielectric material of the present invention is particularly effective when the average crystal grain diameter has to be made smaller, specifically, when the average crystal grain diameter is 0.1 to 0.5 μm. Also, when the average crystal grain diameter becomes smaller, the IR lifetime becomes longer and a change of capacity over time under a direct current electric field becomes smaller. Therefore, the average crystal grain diameter is preferably small as above also from this point.

The Curie's temperature (a phase transition temperature from ferroelectrics to paraelectrics) of a dielectric ceramic composition may be changed by selecting the composition, and to satisfy the X8R characteristics, it is preferably 120° C. or higher and, more preferably, 123° C. or higher. Note that the Curie's temperature can be measured by DSC (differential scanning calorimetry), etc.

A thickness of one dielectric layer composed of the dielectric ceramic composition is normally 40 μm or thinner and particularly 30 μm or thinner. The lower limit of the thickness is normally 2 μm or so. The dielectric ceramic composition of the present embodiment is effective to improve a capacity-temperature characteristic of a multilayer ceramic capacitor having such a thin dielectric layer. Note that the number of stacked dielectric layers is normally 2 to 300 or so.

A multilayer ceramic capacitor using the dielectric ceramic composition is suitable when used as an electronic device for an apparatus used under an environment of 80° C. or higher, particularly, 125 to 150° C. In such a temperature range, the temperature characteristic of capacitance satisfies the R characteristic of the EIA standard and, furthermore, satisfies the X8R characteristics.

A metal to be included in the internal electrode layers 3 is not particularly limited, but since the component of the dielectric layers 2 has reduction resistance, base metals may be used. As base metals, Ni or a Ni alloy is preferable. As a Ni alloy, alloys of one or more kinds of elements selected from Mn, Cr, Co and Al with Ni are preferable, and a Ni content in the alloy is preferably 95 wt % or larger. Note that Ni or a Ni alloy may include a variety of trace components, such as P, in an amount of not larger than 0.1 wt % or so. A thickness of the internal electrode layers may be suitably determined in accordance with application, etc., but normally it is 0.5 to 5 μm, and particularly 0.5 to 2.5 μm or so is preferable.

A base metal to be included in the external electrode 4 is not particularly limited and inexpensive Ni, Cu and alloys of these may be used. A thickness of the external electrode may be suitably determined in accordance with application, etc. but normally 10 to 50 μm or so is preferable.

A multilayer ceramic capacitor using a dielectric is produced by forming a green chip by a normal printing method or a sheet method using paste, firing the same, then, printing or transferring external electrodes and firing in the same way as in a multilayer ceramic capacitor of the related arts. Below, the production method will be explained specifically.

First, a dielectric powder included in dielectric layer paste is prepared and made to form slurry, so that dielectric layer paste is fabricated.

The dielectric layer paste may be organic based slurry obtained by kneading the dielectric ceramic composition powder and an organic vehicle, or water-based slurry.

As the dielectric material powder, the above oxides, mixture of them and composite oxides may be used, and furthermore, a variety of compounds to be the oxides and composite oxides when fired, such as carbonate, oxalate, nitrate, hydroxide and organic metal compound, etc., may be suitably selected and mixed for use. Contents of respective compounds in the dielectric material powder may be determined so as to attain a composition of the above dielectric after firing.

An average particle diameter of the dielectric material powder is normally 0.1 to 3 μm or so in a state before formed to be slurry.

An organic vehicle is obtained by dissolving a binder in an organic solvent. The binder to be used for the organic vehicle is not particularly limited and may be suitably selected from a variety of normal binders, such as ethyl cellulose and polyvinyl butyral. Also, the organic solvent to be used is not particularly limited and may be suitably selected from a variety of organic solvents, such as terpineol, butyl carbitol, acetone and toluene, in accordance with a method to be used, such as a printing method and sheet method.

When using water based slurry as dielectric layer paste, a water based vehicle obtained by dissolving a water-soluble binder and dispersant, etc. in water is kneaded with a dielectric material. The water-soluble binder used for the water based vehicle is not particularly limited and, for example, polyvinyl alcohol, cellulose and a water-soluble acrylic resin, etc. may be used.

Internal electrode paste includes conductive particles, co-material particles and an organic vehicle. As the conductive particles, for example, Ni and a Ni alloy are used and a Ni powder is preferably used. It is because the conductive particles are required to have a higher melting point than a sintering temperature of the dielectric powder included in the dielectric layers, not to react with the dielectric powder, not to be dispersed in the dielectric layer after firing and not to be costly, etc. The co-material particles are not particularly limited as far as it is a ceramic powder, but a BaTiO₃ powder is preferably used.

An average particle diameter of the conductive particles to be used in the internal electrode paste is 0.3 to 0.5 μm. When assuming that an average particle diameter of the conductive particles is a and that of the co-material particles is β, those satisfying α/β of 0.8 to 8.0, preferably, 1.0 to 5.0 are used as the BaTiO₃ particles as the co-material particles. In the internal electrode layer paste, the co-material particles is added in an amount of 30 to 65 wt % (note that 30 wt % and 65 wt % are not included), preferably, larger than 40 wt % but not larger than 60 wt % with respect to 100 parts by weight of the conductive particles. The internal electrode paste is fabricated by kneading the conductive particles, co-material particles and an organic vehicle. As the organic vehicle, those used for the dielectric layer paste may be used.

External electrode paste may be fabricated in the same way as the above internal electrode layer paste explained above.

A content of the organic vehicle in each paste explained above is not particularly limited and may be a normal content, for example, the binder may be 1 to 5 wt % or so and the solvent may be 10 to 50 wt % or so. Also, additives selected from a variety of dispersants, plasticizers, dielectrics and insulators, etc. may be included in each paste in accordance with need. A total content thereof is preferably 10 wt % or smaller.

When using the printing method, the dielectric layer paste and the internal electrode layer paste are stacked by printing on a support film, such as PET, cut into a predetermined shape, and then, removed from the support film to obtain a green chip.

When using the sheet method, the dielectric layer paste is used to form a green sheet, the internal electrode layer paste is printed thereon, and then, the results are stacked to obtain a green chip.

Before firing, binder removal processing is performed on the green chip. The binder removal processing may be suitably determined in accordance with a kind of a conductive material in the internal electrode layer paste, but when using Ni, a Ni alloy or other base metal as the conductive material, an oxygen partial pressure in the binder removal atmosphere is preferably 10⁻⁴⁵ to 10⁵ Pa. When the oxygen partial pressure is lower than the above range, the binder removal effect tends to decline, while when exceeding the range, the internal electrode layers tend to be oxidized.

As other binder removal condition, the temperature raising rate is preferably 5 to 300° C./hour and more preferably 10 to 100° C./hour, the holding temperature is preferably 180 to 400° C. and more preferably 200 to 350° C., and the temperature holding time is preferably 0.5 to 24 hours, and more preferably 2 to 20 hours. The firing atmosphere is preferably in the air or a reducing atmosphere. As an atmosphere gas in the reducing atmosphere, for example, a wet mixed gas of N₂ and H₂ is preferably used.

An atmosphere at firing the green chip may be suitably determined in accordance with a kind of a conductive material in the internal electrode layer paste, but when using a base metal, such as Ni or a Ni alloy, as the conductive material, an oxygen partial pressure in the firing atmosphere is preferably 10⁻⁷ to 10⁻³ Pa. When the oxygen partial pressure is lower than the above range, the conductive material in the internal electrode layer results in abnormal sintering to be broken in some cases. On the other hand, when the oxygen partial pressure exceeds the above range, the internal electrode layers tend to be oxidized.

Also, the holding temperature at firing is preferably 1100 to 1400° C., more preferably 1200 to 1380° C., and furthermore preferably 1260 to 1360° C. When the holding temperature is lower than the above range, densification becomes insufficient, while when exceeding the above range, breakings of electrodes due to abnormal sintering of the internal electrode layer, deterioration of capacity-temperature characteristics due to dispersion of the internal electrode layer component, and reduction of the dielectric ceramic composition are easily caused.

As other firing condition, the temperature raising rate is preferably 50 to 500° C./hour and more preferably 200 to 300° C./hour, the temperature holding time is preferably 0.5 to 8 hours and more preferably 1 to 3 hours, and the cooling rate is preferably 50 to 500° C./hour and more preferably 200 to 300° C./hour. The firing atmosphere is preferably a reducing atmosphere and a preferable atmosphere gas is, for example, a wet mixed gas of N₂ and H₂.

When firing in a reducing atmosphere, it is preferable that annealing is performed on the capacitor element body. Annealing is processing for re-oxidizing the dielectric layers and the IR lifetime is remarkably elongated thereby, so that the reliability is improved.

An oxygen partial pressure in the annealing atmosphere is preferably 0.1 Pa or higher, and particularly preferably 0.1 to 10 Pa. When the oxygen partial pressure is lower than the above range, re-oxidization of the dielectric layers becomes difficult, while when exceeding the above range, the internal electrode layers tend to be oxidized.

The holding temperature at annealing is preferably 1100° C. or lower, and particularly preferably 500 to 1100° C. When the holding temperature is lower than the above range, oxidization of the dielectric layers becomes insufficient, so that the IR becomes low and the IR lifetime becomes short easily. On the other hand, when the holding temperature exceeds the above range, not only the internal electrode layer is oxidized to reduce the capacity, but the internal electrode layer reacts with the dielectric base material, and deterioration of the capacity-temperature characteristic, a decline of the IR and a decline of the IR lifetime are easily caused. Note that annealing may be composed only of a temperature raising step and a temperature lowering step. Namely, the temperature holding time may be zero. In that case, the holding temperature is synonym of the highest temperature.

As other annealing condition, the temperature holding time is preferably 0 to 20 hours and more preferably 2 to 10 hours, and the cooling rate is preferably 50 to 500° C./hour and more preferably 100 to 300° C./hour. Also, a preferable atmosphere gas at annealing is, for example, a wet N₂ gas, etc.

In the above binder removal processing, firing and annealing, for example, a wetter, etc. may be used to wet the N₂ gas and mixed gas, etc. In that case, the water temperature is preferably 5 to 75° C. or so.

The binder removal processing, firing and annealing may be performed continuously or separately. When performing continuously, the atmosphere is changed without cooling after the binder removal processing, and continuously, the temperature is raised to the holding temperature at firing to perform firing. Next, it is cooled and annealing is preferably performed by changing the atmosphere when the temperature reaches to the holding temperature of the annealing. On the other hand, when performing them separately, at the time of firing, after raising the temperature to the holding temperature of the binder removal processing in an atmosphere of a N₂ gas or a wet N₂ gas, the atmosphere is changed, and the temperature is preferably furthermore raised. Then, after cooling the temperature to the holding temperature of the annealing, it is preferable that the cooling continues by changing the atmosphere again to a N₂ gas or a wet N₂ gas. Also, in the annealing, after raising the temperature to the holding temperature under the N₂ gas atmosphere, the atmosphere may be changed, or the entire process of the annealing may be in a wet N₂ gas atmosphere.

End surface polishing, for example, by barrel polishing or sand blast, etc. is performed on the capacitor element body obtained as above, and the external electrode paste is printed or transferred and fired to form external electrodes 4. Firing condition of the external electrode paste is preferably, for example, in a wet mixed gas of N₂ and H₂ at 600 to 800° C. for 10 minutes to 1 hour or so. A cover layer is formed by plating, etc. on the surface of the external electrodes 4 if necessary.

A multilayer ceramic capacitor of the present invention produced as above is mounted on a print substrate, etc. by soldering, etc. and used for a variety of electronic apparatuses, etc.

An embodiment of the present invention was explained above, but the present invention is not limited to the above embodiment and may be variously modified within the scope of the present invention.

For example, in the above embodiment, a multilayer ceramic capacitor was explained as an example of an electronic device according to the present invention, but an electronic device according to the present invention is not limited to the multilayer ceramic capacitor and may be any as far as it includes a dielectric layer composed of a dielectric ceramic composition having the above composition.

Below, the present invention will be explained based on furthermore detailed examples, but the present invention is not limited to the examples.

### EXAMPLE 1

First, as starting materials for producing a dielectric ceramic composition, a main component material (BaTiO₃) and subcomponent materials were prepared. In the present example, BaTiO₃ having an average particle diameter of 0.30 μm was used as the main component material.

As the subcomponent materials, the following materials were used. Carbonates (the first subcomponent: MgCO₃, the fifth subcomponent: MnCO₃) were used as materials of MgO and MnO, and oxides (the second subcomponent: (Ba_{0.6} Ca_{0.4})SiO₃, the third subcomponent: V₂O₅, the fourth subcomponent: Yb₂O₃+Y₂O₃, the sixth subcomponent: CaZrO₃ and other subcomponent: Al₂O₃) were used as other materials.

The second subcomponent (Ba_{0.6} Ca_{0.4})SiO₃ is produced by wet mixing BaCO₃, CaCO₃ and SiO₂ by a ball mill for 16 hours, drying, firing at 1150° C. in the air and, furthermore, performing wet pulverization by a ball mill for 100 hours. The fifth subcomponent CaZrO₃ is produced by wet mixing CaCO₃ and ZrO₂ by a ball mill for 16 hours, drying, firing at 1150° C. in the air and, furthermore, performing wet pulverization by a ball mill for 24 hours.

Note that, for the main component BaTiO₃, same characteristics were obtained by using what produced by respectively weighing BaCO₃ and TiO₂, wet mixing by using a ball mill for about 16 hours, drying, firing at 1100° C. in the air and performing wet pulverization by a ball mill for about 16 hours. Also, as the main component BaTiO₃, the same characteristics were obtained by using what produced by the hydrothermal synthesis method or oxalate method, etc.

These materials were compounded so that a composition after firing becomes MgCO₃: 1 mole, (Ba_{0.6} Ca_{0.4})SiO₃: 3 moles, V₂O₅: 0.1 mole, Yb₂O₃: 1.75 moles, Y₂O₃: 2 moles, MnCO₃: 0.374 mole, CaZrO₃: 2.0 moles and Al₂O₃: 1 mole with respect to 100 moles of the main component BaTiO₃, wet mixed by a ball mill for 16 hours and dried to obtain a dielectric ceramic composition.

Next, the obtained dried dielectric ceramic composition in an amount of 100 parts by weight, an acrylic resin in an amount of 4.8 parts by weight, ethyl acetate in an amount of 100 parts by weight, mineral spirit in an amount of 6 parts by weight and toluene in an amount of 4 parts by weight were mixed by a ball mill to form paste, so that dielectric layer paste was obtained.

Next, with respect to 100 parts by weight of Ni particles respectively having an average particle diameter of 0.3, 0.4 and 0.5 μm as shown in Table 1, a BaTiO₃ powder (BT-01 of Sakai Chemical Industry Co., Ltd.), wherein an average particle diameter is changed as shown in Table 1, in an amount of 60 parts by weight, an organic vehicle (obtained by dissolving ethyl cellulose in an amount of 3 parts by weight in butyl carbitol in an amount of 92 parts by weight) in an amount of 40 parts by weight and butyl carbitol in an amount of 10 parts by weight were kneaded by a triple-roll to form paste and internal electrode layer paste, wherein an amount of the co-material BaTiO₃ of Ni is 60 wt %, was obtained.

Next, Cu particles having an average particle diameter of 0.5 μm in an amount of 100 parts by weight, an organic vehicle (obtained by dissolving ethyl cellulose in an amount of 8 parts by weight in butyl carbitol in an amount of 92 parts by weight) in an amount of 35 parts by weight and butyl carbitol in an amount of 7 parts by weight were kneaded to from paste, so that external electrode paste was obtained.

Next, the dielectric layer paste was used to form a green sheet having a thickness of 10 μm on a PET film, the internal electrode layer paste was printed thereon, and then, the green sheet was removed from the PET film.

Then, the green sheets and protective green sheets (without the internal electrode layer paste printed thereon) were stacked and bonded by pressure, so that a green chip was obtained. The number of stacked sheets having internal electrodes was 160.

Next, the green chip was subjected to binder removal processing, firing and annealing, so that a multilayer ceramic fired body was obtained.

The binder removal processing was performed under a condition that the temperature raising rate was 15° C./hour, the holding temperature was 280° C., the holding time was 2 hours and the atmosphere is in the air.

The firing was performed under a condition that the temperature raising rate was 200° C./hour, the holding temperature was 1260 to 1340° C., the holding time was 2 hours, the cooling rate was 300° C./hour and the atmosphere is in a wet mixed gas of N₂+H₂ (oxygen partial pressure was 10⁻⁶ Pa).

The annealing was performed under a condition that the holding temperature was 1200° C., the temperature holding time was 2 hours, the cooling rate was 300° C./hour and the atmosphere is in a nitrogen atmosphere. Note that a wetter with a water temperature of 35° C. was used to wet the atmospheres in the binder removal processing and firing.

Next, after polishing end surfaces of the multilayer ceramic fired body by sand blast, the external electrode paste was transferred to the end surfaces and external electrodes were formed by firing at 800° C. in a wet N₂+H₂ atmosphere for 10 minutes, so that multilayer ceramic capacitor samples having the configuration shown in FIG. 1 were obtained.

A size of the obtained capacitor samples was 3.2 mm×1.6 mm×1.6 mm the number of internal electrode layers sandwiched by dielectric layers was 160, a thickness of one dielectric layer was 7.0 μm, and a thickness of one internal electrode layer was 1.0 μm.

### Measurement of Outermost Layer Coverage Rate

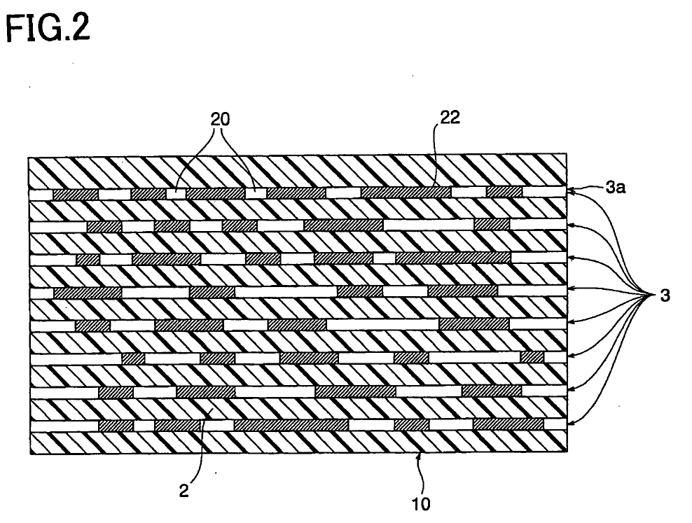

An electrode coverage rate of an internal electrode was obtained by cutting a multilayer ceramic capacitor sample so that the electrode surface was exposed, performing SEM observation on the electrode surface and performing image processing on a metallographic microscope image of the polished surface. When cutting on a surface being parallel with the stacking direction, each of the internal electrodes is observed in a linear shape, and holes on the electrode surface are observed as electrode breakings 20 as shown in FIG. 2. On the outermost layer electrode surface 3a shown in FIG. 2, a total length of an electrode linear parts 22 was measured excepting the electrode breakings 20 in a scope length, and a rate of the total length of the electrode linear parts 22 to the scope length was used as the electrode coverage rate (%). Specifically, a total length of the electrode linear parts 22 (that is, a length excepting the breaking parts 20 from the scope length) was obtained and a rate of the total length of the electrode linear amount 22 to the scope length was calculated to obtain the electrode coverage rate. Note that the electrode coverage rate was obtained by using five metallographic microscope images and measuring the scope length of 100 μm. The results of the outermost layer coverage rates are shown in Table 1.

### Humidity Resistance Test

Capacitor samples were placed in an atmosphere with a temperature of 85° C. and relative humidity of 80%, a voltage of 50V was applied to the capacitor samples and time until the resistance falls by one digit was measured. The longer the time is, the more excellent in humidity resistance. In the humidity resistance test, 1500 hours or longer were evaluated “o” and those shorter than that were evaluated “x”. The results of the humidity resistance test are shown in Table 1.

Table 1

TABLE 1
Example 1: Co-material Amount 60 wt %

| | BT | | Outermost | | |
|---|---|---|---|---|---|
| Ni Particle | Particle | | Layer | Humidity | Humidity |
| Diameter | Diameter | | Coverage | Resistance | Resistance |
| (μm) | (μm) | Ni/BT | Rate (%) | Test (h) | Evaluation |
| 0.3 | 0.01 | 30.0 | 58 | 800 | X |
| | 0.05 | 6.0 | 79 | >2100 | ◯ |
| | 0.1 | 3.0 | 85 | >2100 | ◯ |
| | 0.2 | 1.5 | 85 | >2100 | ◯ |
| | 0.3 | 1.0 | 78 | >2100 | ◯ |
| | 0.4 | 0.8 | 68 | 1670 | ◯ |
| | 0.5 | 0.6 | 45 | 200 | X |
| 0.4 | 0.01 | 40.0 | 57 | 1100 | X |
| | 0.05 | 8.0 | 87 | >2100 | ◯ |
| | 0.1 | 4.0 | 95 | >2100 | ◯ |
| | 0.2 | 2.0 | 91 | >2100 | ◯ |
| | 0.3 | 1.3 | 82 | >2100 | ◯ |
| | 0.4 | 1.0 | 80 | >2100 | ◯ |
| | 0.5 | 0.8 | 77 | 1800 | ◯ |
| | 0.6 | 0.7 | 58 | 878 | X |
| 0.5 | 0.05 | 10.0 | 49 | 980 | X |
| | 0.1 | 5.0 | 78 | >2100 | ◯ |
| | 0.3 | 1.7 | 86 | >2100 | ◯ |
| | 0.6 | 0.8 | 73 | >2100 | ◯ |
| | 0.7 | 0.7 | 50 | 655 | X |

### EXAMPLE 2

Other than changing the weight ratio of the BaTiO₃ particles as a co-material of Ni particles to 50 wt % when producing the internal electrode paste, samples were produced and evaluated in the same ways as in the example 1. The results are shown in Table 2.

Table 2

TABLE 2
Example 2: Co-material Amount 50 wt %

| Ni | BT | | Outermost | | |
|---|---|---|---|---|---|
| Particle | Particle | | Layer | Humidity | Humidity |
| Diameter | Diameter | | Coverage | Resistance | Resistance |
| (μm) | (μm) | Ni/BT | Rate (%) | Test (h) | Evaluation |
| 0.3 | 0.01 | 30.0 | 56 | 980 | X |
| | 0.05 | 6.0 | 81 | >2200 | ◯ |
| | 0.1 | 3.0 | 91 | >2200 | ◯ |
| | 0.2 | 1.5 | 90 | >2200 | ◯ |
| | 0.3 | 1.0 | 83 | >2200 | ◯ |
| | 0.4 | 0.8 | 71 | 1809 | ◯ |
| | 0.5 | 0.6 | 50 | 498 | X |
| 0.4 | 0.01 | 40.0 | 57 | 1100 | X |
| | 0.05 | 8.0 | 87 | >2200 | ◯ |
| | 0.1 | 4.0 | 95 | >2200 | ◯ |
| | 0.2 | 2.0 | 91 | >2200 | ◯ |
| | 0.3 | 1.3 | 82 | >2200 | ◯ |
| | 0.4 | 1.0 | 80 | >2200 | ◯ |
| | 0.5 | 0.8 | 77 | 1800 | ◯ |
| | 0.6 | 0.7 | 58 | 878 | X |
| 0.5 | 0.05 | 10.0 | 50 | 1231 | X |
| | 0.1 | 5.0 | 85 | >2200 | ◯ |
| | 0.3 | 1.7 | 97 | >2200 | ◯ |
| | 0.6 | 0.8 | 80 | >2200 | ◯ |
| | 0.7 | 0.7 | 58 | 1004 | X |

### EXAMPLE 3

Other than changing the weight ratio of the BaTiO₃ particles as a co-material of Ni particles to 40 wt % when producing the internal electrode paste, samples were produced in the same way as in the example 1 and the same evaluations were made. The results are shown in Table 3.

Table 3

TABLE 3
Example 3: Co-material Amount 40 wt %

| Ni | BT | | Outermost | | |
|---|---|---|---|---|---|
| Particle | Particle | | Layer | Humidity | Humidity |
| Diameter | Diameter | | Coverage | Resistance | Resistance |
| (μm) | (μm) | Ni/BT | Rate (%) | Test (h) | Evaluation |
| 0.3 | 0.01 | 30.0 | 53 | 800 | X |
| | 0.05 | 6.0 | 73 | >2000 | ◯ |
| | 0.1 | 3.0 | 85 | >2000 | ◯ |
| | 0.2 | 1.5 | 90 | >2000 | ◯ |
| | 0.3 | 1.0 | 80 | >2000 | ◯ |
| | 0.4 | 0.8 | 70 | 1710 | ◯ |
| | 0.5 | 0.6 | 58 | 720 | X |
| 0.4 | 0.01 | 40.0 | 59 | 900 | X |
| | 0.05 | 8.0 | 87 | >2000 | ◯ |
| | 0.1 | 4.0 | 95 | >2000 | ◯ |
| | 0.2 | 2.0 | 91 | >2000 | ◯ |
| | 0.3 | 1.3 | 95 | >2000 | ◯ |
| | 0.4 | 1.0 | 80 | >2000 | ◯ |
| | 0.5 | 0.8 | 74 | 1780 | ◯ |
| | 0.6 | 0.7 | 55 | 878 | X |
| 0.5 | 0.05 | 10.0 | 57 | 871 | X |
| | 0.1 | 5.0 | 85 | >2000 | ◯ |
| | 0.3 | 1.7 | 97 | >2000 | ◯ |
| | 0.6 | 0.8 | 80 | >2000 | ◯ |
| | 0.7 | 0.7 | 67 | 1455 | X |

### EXAMPLE 4

Other than changing the weight ratio of the BaTiO₃ particles as a co-material of Ni particles to 35 wt % when producing the internal electrode paste, samples were produced in the same way as in the example 1 and the same evaluations were made. The results are shown in Table 4.

Table 4

TABLE 4
Example 4: Co-material Amount 35 wt %

| Ni | BT | | Outermost | | |
|---|---|---|---|---|---|
| Particle | Particle | | Layer | Humidity | Humidity |
| Diameter | Diameter | | Coverage | Resistance | Resistance |
| (μm) | (μm) | Ni/BT | Rate (%) | Test (h) | Evaluation |
| 0.3 | 0.01 | 30.0 | 50 | 750 | X |
| | 0.05 | 6.0 | 63 | >2000 | ◯ |
| | 0.1 | 3.0 | 80 | >2000 | ◯ |
| | 0.2 | 1.5 | 85 | >2000 | ◯ |
| | 0.3 | 1.0 | 76 | >2000 | ◯ |
| | 0.4 | 0.8 | 67 | 1600 | ◯ |
| | 0.5 | 0.6 | 58 | 704 | X |
| 0.4 | 0.01 | 40.0 | 53 | 898 | X |
| | 0.05 | 8.0 | 87 | >2000 | ◯ |
| | 0.1 | 4.0 | 95 | >2000 | ◯ |
| | 0.2 | 2.0 | 91 | >2000 | ◯ |
| | 0.3 | 1.3 | 95 | >2000 | ◯ |
| | 0.4 | 1.0 | 80 | >2000 | ◯ |
| | 0.5 | 0.8 | 67 | 1677 | ◯ |
| | 0.6 | 0.7 | 57 | 878 | X |
| 0.5 | 0.05 | 10.0 | 56 | 1265 | X |
| | 0.1 | 5.0 | 85 | >2000 | ◯ |
| | 0.3 | 1.7 | 97 | >2000 | ◯ |
| | 0.6 | 0.8 | 80 | >2000 | ◯ |
| | 0.7 | 0.7 | 67 | 1255 | X |

### COMPARATIVE EXAMPLE 1

Other than changing the weight ratio of the BaTiO₃ particles as a co-material of Ni particles to 30 wt % when producing the internal electrode paste, samples were produced in the same way as in the example 1 and the same evaluations were made. The results are shown in Table 5.

Table 5

TABLE 5
Comparative Example 1: Co-material Amount 30 wt %

| Ni | BT | | Outermost | | |
|---|---|---|---|---|---|
| Particle | Particle | | Layer | Humidity | Humidity |
| Diameter | Diameter | | Coverage | Resistance | Resistance |
| (μm) | (μm) | Ni/BT | Rate (%) | Test (h) | Evaluation |
| 0.3 | 0.01 | 30.0 | 10 | 98 | X |
| | 0.05 | 6.0 | 21 | 676 | X |
| | 0.1 | 3.0 | 34 | 771 | X |
| | 0.2 | 1.5 | 43 | 671 | X |
| | 0.3 | 1.0 | 21 | 500 | X |
| | 0.4 | 0.8 | 10 | 125 | X |
| | 0.5 | 0.6 | 0 | 78 | X |
| 0.4 | 0.01 | 40.0 | 24 | 544 | X |
| | 0.05 | 8.0 | 35 | 802 | X |
| | 0.1 | 4.0 | 47 | 722 | X |
| | 0.2 | 2.0 | 42 | 700 | X |
| | 0.3 | 1.3 | 31 | 600 | X |
| | 0.4 | 1.0 | 27 | 566 | X |
| | 0.5 | 0.8 | 0 | 90 | X |
| 0.5 | 0.05 | 10.0 | 7 | 60 | X |
| | 0.1 | 5.0 | 38 | 800 | X |
| | 0.3 | 1.7 | 50 | 803 | X |
| | 0.6 | 0.8 | 31 | 599 | X |
| | 0.7 | 0.7 | 22 | 400 | X |

### COMPARATIVE EXAMPLE 2

Other than changing the weight ratio of the BaTiO₃ particles as a co-material of Ni particles to 65 wt % when producing the internal electrode paste, the same attempts as in the example 1 was made to produce samples. However, when the co-material amount becomes 65 wt % or larger, the paste viscosity becomes high, so that printing was impossible.

The followings are learnt from Table 1 to Table 5.

When the co-material amount was 30 to 65 wt % (note that 30 wt % and 65 wt % are not included) and (Ni particle diameter)/(BaTiO₃ particle diameter) was 0.8 to 8.0, it was confirmed that 1500 hours or longer was exhibited in the humidity resistance test and outermost layer coverage rates were 60% or higher. Particularly, when the co-material amount is 40 to 65 wt % (note that 40 wt % and 65 wt % are not included), preferably, 40 to 60 wt % (note that 40 wt % is not included) and (Ni particle diameter)/(BaTiO₃ particle diameter) was 1.0 to 5.0, it was confirmed that longer than 2100 hours was exhibited in the humidity resistance test and the outermost layer coverage rates were 75% or higher. The longer the durable time was in the humidity resistance test, the higher the outermost layer coverage rate was. Therefore, it is considered that the coverage rate becomes high and the humidity resistance improves when increasing the co-material.

### EXAMPLE 5

Capacitance was measured on samples with (Ni particle diameter)/(BaTiO₃ particle diameter) of 4.0 and co-material amounts of 20, 30, 40, 50 and 60 wt %, respectively. The results are shown in Table 6. It was confirmed that the larger the co-material amount was, the higher the capacitance was.

Table 6

TABLE 6

| Co-material | |
|---|---|
| Amount | Capacitance |
| (wt %) | (μF) |
| 20 | 0.80 |
| 30 | 0.96 |
| 40 | 1.11 |
| 50 | 1.33 |
| 60 | 1.50 |

1. A production method of a multilayer electronic device configured that dielectric layers formed by using dielectric paste and internal electrode layers formed by using conductive paste are alternately stacked:
wherein
said conductive paste is added with conductive particles and co-material particles;
when assuming that an average particle diameter of the conductive particles is α and an average particle diameter of the co-material particles is β in said conductive paste, α/β is 0.8 to 8.0; and
said co-material particles are added by a ratio of larger than 30 wt % and smaller than 65 wt % with respect to 100 parts by weight of said conductive particles.

2. The production method of a multilayer electronic device as set forth in claim 1, wherein Ni particles are used as said conductive particles.

3. The production method of a multilayer electronic device as set forth in claim 1, wherein BaTiO₃ particles are used as said co-material particles.

4. The production method of a multilayer electronic device as set forth in claim 1, wherein a ratio of said co-material particle is 40 wt % or larger to 60 wt % or smaller.

5. The production method of a multilayer electronic device as set forth in claim 1, wherein α/β is 1.0 to 5.0.

6. A multilayer electronic device produced by the production method as set forth in claim 1.

7. The multilayer electronic device as set forth in claim 6, wherein a length is 2.0 mm or longer and a width is 1.2 mm or longer.

8. The multilayer electronic device as set forth in claim 6, wherein the number of stacked layers of said dielectric layers is 100 or larger.

9. The multilayer electronic device as set forth in claim 6, wherein an electrode coverage rate of the outermost layer of said internal electrode layers in the stacking direction is 60% or higher.

10. The production method of a multilayer electronic device as set forth in claim 2, wherein BaTiO₃ particles are used as said co-material particles.

11. The production method of a multilayer electronic device as set forth in claim 2, wherein a ratio of said co-material particle is 40 wt % or larger to 60 wt % or smaller.

12. The production method of a multilayer electronic device as set forth in claim 2, wherein α/β is 1.0 to 5.0.

13. A multilayer electronic device produced by the production method as set forth in claim 2.

14. The multilayer electronic device as set forth in claim 13, wherein a length is 2.0 mm or longer and a width is 1.2 mm or longer.

15. The multilayer electronic device as set forth in claim 13, wherein the number of stacked layers of said dielectric layers is 100 or larger.

16. The multilayer electronic device as set forth in claim 13, wherein an electrode coverage rate of the outermost layer of said internal electrode layers in the stacking direction is 60% or higher.
